(19) United States
(12) Patent Application Publication
(10) Pub. No.: US 2024/0195703 A1
(43) Pub. Date: Jun. 13, 2024

(54) KEY PERFORMANCE INDICATOR MONITORING VIEW APPARATUS AND METHOD

(71) Applicant: Rakuten Mobile, Inc., Tokyo (JP)

(72) Inventors: Vishvesh TRIVEDI, Tokyo (JP); Anshul BHATT, Tokyo (JP); Dhananjay CHAUBEY; Alok Singh PAWAR, Madhya Pradesh (IN); Manish PATIDAR

(21) Appl. No.: 17/756,819

(22) PCT Filed: Apr. 20, 2022
(86) PCT No.: PCT/US2022/025528

§ 371 Date: Jun. 3, 2022

(51) Int. Cl. H04L 41/22; H04L 41/5009

(52) U.S. Cl. CPC H04L 41/22; H04L 41/5009

(57) ABSTRACT

A method includes processing one or more parameter selection inputs from a graphical user interface. The graphical user interface includes a plurality of parameter input fields. Each parameter input field receives a parameter selection corresponding to a detail for identifying one or more key performance indicators (KPIs) associated with monitoring a communication network. The method includes causing a list of KPIs in the graphical user interface to be narrowed based on the processing of the one or more user inputs received by one or more of the plurality of parameter input fields. The method includes processing a selection to view one or more KPIs included in the list of KPIs. The method includes processing one or more hierarchy selection inputs received by way of the graphical user interface to cause a KPI value for each of the one or more selected KPIs to be generated and output to a display.

### BACKGROUND

Network operators, network service providers and device manufacturers (e.g., wireless, cellular, etc.) are continually challenged to deliver value and convenience to consumers by, for example, providing compelling communication networks and network services that are dependable and capable of being flexibly constructed, scalable, diverse, and economically operated. To provide such communication networks and network services, network operators, network service providers and device manufacturers often track key performance indicators (KPIs) that are indicative of an operating state of a communication network and/or various network services and/or network devices.

### BRIEF DESCRIPTION OF DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a diagram of a KPI monitoring and centralized data storage system, in accordance with one or more embodiments.

FIG. 2 is a diagram of a graphical user interface, in accordance with one or more embodiments.

FIG. 3 is a diagram of a graphical user interface, in accordance with one or more embodiments.

FIG. 4 is a diagram of a graphical user interface, in accordance with one or more embodiments.

FIG. 5 is a diagram of a graphical user interface, in accordance with one or more embodiments.

FIG. 6 is a diagram of a graphical user interface, in accordance with one or more embodiments.

FIG. 7 is a diagram of a graphical user interface, in accordance with one or more embodiments.

FIG. 8 is a diagram of a graphical user interface, in accordance with one or more embodiments.

FIG. 9 is a flowchart of a process for selective monitoring and displaying one or more KPI values, in accordance with one or more embodiments.

FIG. 10 is a functional block diagram of a computer or processor-based system upon which or by which an embodiment is implemented.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation or position of a first feature over or on a second feature in the description that follows may include embodiments in which the first and second features are formed or positioned in direct contact, and may also include embodiments in which additional features may be formed or positioned between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of an apparatus or object in use or operation in addition to the orientation depicted in the figures. The apparatus may be otherwise oriented (rotated 90 degrees or at other orientations) and the spatially relative descriptors used herein may likewise be interpreted accordingly.

Communication networks and network services are often provided by static or inflexible systems that are difficult to configure, scale, and deploy over various target areas. Dependable provision of communication networks and/or network services that are capable of being flexibly constructed, scalable and diverse is often reliant on the collection, analysis and reporting of information regarding multiple network functions, network services, network devices, etc. that affect the performance, accessibility, configuration, scale, and/or deployment of a communication network, various network functions, network services, and the like.

Network service providers often deploy network monitoring systems that track various key performance indicators (KPIs) of an aspect of a network for determining how well that aspect and/or the network is performing. KPIs are often KPI values and/or trends that are compared to certain thresholds to indicate the relative performance of a communication network, network service, network device, etc. The KPI values are often based on monitoring data referred to herein as system data.

Sometimes, when a KPI value for a certain network function, network service or feature is below a preset threshold, the KPI value may imply that the network is operating normally, whereas when the KPI value is above or equal to the preset threshold, the KPI value implies that the network is operating below expectation, which in turn may indicate that some unexpected event (e.g., a hardware failure, capacity overload, a cyberattack, etc.) has occurred. Accordingly, a series of actions can be carried out by the network monitoring system such as alerting the network operator, shifting a network function from a problematic server to a healthy server, temporarily shutting down the network, or some other suitable action. Of course, depending on the network configuration, a condition in which the KPI value is higher than or equal to a threshold can also indicate that the network is operating normally, while a condition in which the KPI value is below the threshold indicates that the network is operating below expectation. Several other types of threshold configurations are possible as the threshold configurations may vary depending on the needs of a specific user or specific network operator, depending on individual preference, type of KPI being monitored, type of KPI created by a user for monitoring, type of system data that is processed for monitoring a KPI, and the like.

Network operators that coordinate and deploy communication networks that include network services (e.g., hardware, software, etc.) provided by one or more network service providers are reliant on system data supplied to the network operator by the one or more network service providers for monitoring KPIs. Such communication networks often involve network services across multiple domains such as radio area network (RAN), base station subsystem (BSS), platform, core network, etc., various technologies (such as 3G, 4G, LTE, 5G, etc.), multiple locations, various software interfaces, multiple devices, etc. that are proprietary and/or optimized by a specific network service provider.

As the communication network evolves and improves, a single communication network may involve an ever-changing quantity of network service providers for providing network services and/or that are associated with providing network services associated with various aspects of the communication network (e.g., domains, technologies, locations of services, etc.) and, as a result, the state of the communication network may vary dynamically with the addition and/or subtraction of network service providers, a change in one or more network services, etc.

Each network service provider often uses a corresponding monitoring system to monitor performance of the network service(s) provided by that network service provider to gather various system data (e.g., raw data, processed data, and/or pre-processed data provided by a network service provider's monitoring system, pre-processed KPI data provided by the network service providers, etc.) usable by the network operator for determining KPI values indicative of the state of the communication network. The network service providers send the system data to the network operator for monitoring the status of the communication network in consideration of the system data associated with the network service(s) provided by each network service provider. For example, the network operator uses the system data supplied by the network service providers to generate KPI value(s) and/or to evaluate the quality of services provided by each of the network service providers.

Network operators consistently check KPIs, for example, to ensure validity and stability of the communication network. Then, based on a determination that an anomaly occurs in one or more KPIs, take an appropriate action such as making a change in network service providers or network devices that are used to provide one or more network services that are malfunctioning to one or more alternative network service providers and/or one or more alternative network devices to ensure the communication network is operating and available for consumers.

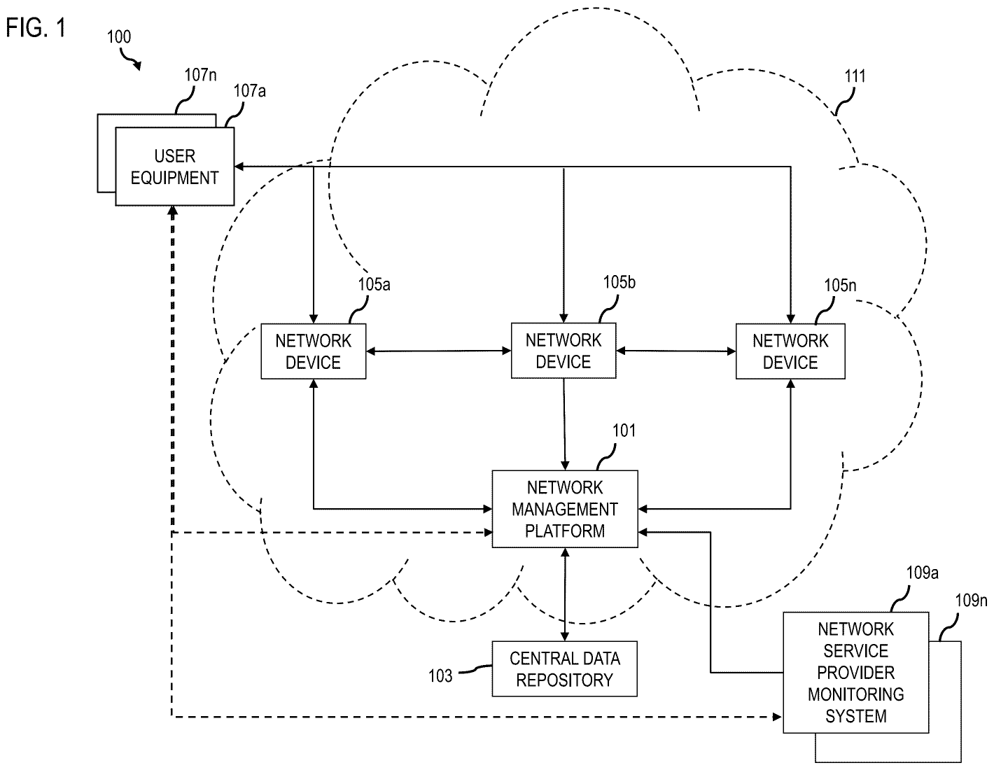

FIG. 1 is a diagram of a KPI monitoring and centralized data storage system 100, in accordance with one or more embodiments.

System 100 makes it possible for a network operator to monitor KPIs associated with a communication network provided by the network operator based on system data received from one or more network service providers that provide network services upon which the communication network is based.

System 100 comprises a network management platform 101, a central data repository 103, one or more network devices 105a-105n (collectively referred to as network devices 105), and one or more user equipment (UE) 107a-107n (collectively referred to as UE 107). The network management platform 101, the central data repository 103, the one or more network devices 105, and/or the one or more user equipment (UE) 107 are communicatively coupled by way of a communication network 111. In some embodiments, the communication network 111 is orchestrated by the network management platform 101 which combines a plurality of network services provided by a network service provider via the network devices 105. In some embodiments, the network management platform 101 is a network orchestrator that implements the communication network 111. In some embodiments, the network management platform 101 is a portion of a network orchestrator that implements the communication network 111.

The network service providers associated with the network services provided have corresponding network service provider monitoring systems 109a-109n (collectively referred to as network service provider monitoring system 109). The network service provider monitoring systems 109 collect system data associated with the network services provided to communication network 111 and send that system data to the network management platform 101 to facilitate monitoring of the state of the communication network 111.

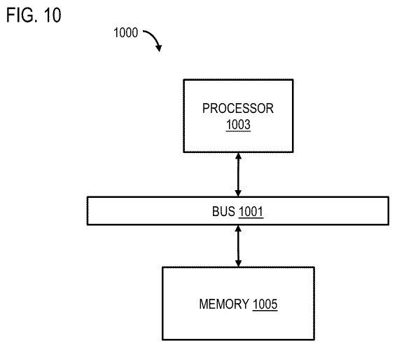

In some embodiments, network management platform 101 comprises a set of computer readable instructions that, when executed by a processor such as a processor 1003 (FIG. 10), causes network management platform 101 to perform the processes discussed in accordance with one or more embodiments. In some embodiments, network management platform 101 is remote from the network devices 105. In some embodiments, network management platform 101 is a part of one or more of the network devices 105. In some embodiments, one or more processes the network management platform 101 is configured to perform is divided among one or more of the network devices 105 and a processor remote from the network devices 105. In some embodiments, the network management platform 101 is at least partially implemented by a UE 107.

In some embodiments, central data repository 103 has searchable information stored therein that includes stored system data, rules defining various KPIs, network functions capable of being implemented in the network involving one or more of network usage, timing, connected devices, location, network resource consumption, cost data, example network KPIs, KPI monitoring profiles corresponding to one or more users, KPI evaluation profiles corresponding to one or more users, other suitable elements or information, or a combination thereof. Central data repository 103 is a memory such as a memory 1005 (FIG. 10) capable of being queried or caused to store data in accordance with one or more embodiments. In some embodiments, the network management platform 101 and the central data repository 103 together form a network orchestrator that implements the communication network 111.

In some embodiments, network management platform 101 generates a graphical user interface that is output to a display by way of a UE 107 or a terminal associated with network management platform 101 for a user (e.g., a network operator, a network administrator, and any personnel which would like to or is responsible to monitor the state of the communication network 111), so as to allow the user to monitor the operating state of the communication network 111. In some embodiments, the user interface is accessible via a web browser such as by way of a website or a web browser plug-in.

The network service provider monitoring system(s) 109 of each of the plurality of network service providers continuously monitor their own corresponding network services and periodically send at predetermined times (e.g., every 5 minutes, every 15 minutes, every 30 minutes, etc.) the monitored system data to the network management platform 101. In some embodiments, the network management platform 101 causes the monitored system data to be stored in the central data repository 103. In some embodiments, the central data repository 103 is controlled by the network operator.

The system data is communicated from the network service provider monitoring systems 109 to the network management platform 101 via one or more of a wireless communication channel, a wired communication channel, enhanced messaging service (EMS), email messaging, data packet transmission, or some other suitable type of data transmission which is optionally the same or different among the plurality of network service providers.

In some embodiments, the network management platform 101 continuously monitors the system data received from the network service provider monitoring system(s) 109 by processing received system data that is stored in the central data repository 103.

In some embodiments, when a user (e.g., a network operator, a network service provider, and/or any personnel that would like to or is responsible to monitor the system) wants to monitor one or more KPIs, the network management platform 101 makes it possible for a user to access to the centralized platform via a UE 107. The network management platform 101 determines the identity of the user based on user credentials, access device, or some other suitable manner, and provides a graphical user interface to the user via a UE 107. In some embodiments, the network management platform 101 limits functions available to the user by way of the graphical user interface depending on the type of user (e.g., a regular user may have access to fewer functions than a VIP user, a network administrator may have access to all functions, etc.).

In use, when a network operator wants to monitor one or more KPIs, the network operator accesses the network management platform 101 by way of the network operator's terminal (e.g., a UE 107 having connectivity to the communication network 111).

After authentication and authorization based on receiving and processing user credentials (e.g., user ID and password, etc.), the network management platform 101 retrieves a user profile of the network operator (e.g., which may be stored in the central data repository 103 or some other suitable memory or database having connectivity to system 100), accesses the central data repository 103 to determine (based on the user profile) which stored system data is related to the network operator, and then generates and presents a list of KPIs that are capable of being viewed by the user by way of the graphical user interface based on the determined stored system data related to the network operator.

In some embodiments, the list of KPIs is extensive and the graphical user interface facilitates selecting one or more of the KPIs included in the list of KPIs for monitoring. The network management platform 101 is configured to process one or more user inputs received by way of the graphical user interface to narrow the list of KPIs according to one or more parameter selections and to then process one or more KPIs that are selected to be monitored. In some embodiments, the graphical user interface having the list of KPIs comprises a plurality of parameter input fields and the network management platform 101 processes one or more parameter selection inputs received by way of the graphical user interface. Each parameter input field of the plurality of parameter input fields, for example, is configured to receive a parameter selection corresponding to a detail for identifying one or more KPIs associated with monitoring a communication network. The network management platform 101 then causes the list of KPIs in the graphical user interface to be narrowed based on the processing of the one or more user inputs received by one or more of the plurality of parameter input fields.

In some embodiments, the list of KPIs is caused to be narrowed based on a determination that all of the plurality of parameter input fields received at least one parameter selection input. In some embodiments, the network management platform 101 is configured to narrow the list of KPIs based on a preset minimum quantity of parameter input fields that received at least one parameter selection input. In some embodiments, one or more of the parameter input fields are identified as being the minimum parameter input fields that are to have received at least one parameter selection input before the network management platform 101 causes the list of KPIs to be narrowed. In some embodiments, the network management platform 101 is configured to cause different combinations of the parameter input fields to be the minimum parameter input fields that are to have received at least one parameter selection input before the network management platform 101 causes the list of KPIs to be narrowed.

For example, if the graphical user interface comprises five parameter input fields A, B, C, D and E, and if parameter input field A receives a parameter selection input, then the network management platform 101 may be configured to indicate that at least parameter input fields B and C are to receive at least one parameter selection input before the network management platform 101 causes the list of KPIs to be narrowed. Similarly, in such an example, if parameter input field D receives a parameter selection input, then the network management platform 101 may be configured to indicate that at least parameter input fields C and E are to receive at least one parameter selection input before the network management platform 101 causes the list of KPIs to be narrowed.

In some embodiments, the one or more parameter input fields are configured to receive user inputs indicating one or more of a domain (e.g., RAN, Core, etc.), a technology (e.g., 5G, LTE, etc.), a network service provider name (e.g., Vendor A, etc.), an element management system type that manages various types of one or more network elements within a telecommunication management network (TMN), an equipment type (e.g., eNodeB, etc.), a node name, a word search, or some other usable information identifiable in the system data upon which the KPIs are determined and based upon which the list of KPIs is capable of being narrowed.

The network management platform 101 is configured to process a selection to view or monitor one or more KPIs included in the list of KPIs. In some embodiments, the selection to view or monitor one or more KPIs included in the list of KPIs is made by dragging and dropping one or more KPIs from the list of KPIs to a KPI selection workspace in the graphical user interface. In some embodiments, the selection to view or monitor one or more KPIs included in the list of KPIs is made by doubling clicking, right clicking, or by some other suitable action, which causes one or more KPIs selected from the list of KPIs to populate the KPI selection workspace in the graphical user interface.

Based on an instruction to view or monitor the selected one or more KPIs, network management platform 101 causes one or more hierarchy selection input options to be displayed by way of the graphical user interface. The network management platform 101 then processes one or more hierarchy selection inputs received by way of the graphical user interface to cause a KPI value for each of the one or more selected KPIs to be generated and output to a display based on the one or more hierarchy selection inputs.

In some embodiments, at least one of the one or more hierarchy selection inputs is received by way of a drill-down menu in the graphical user interface. In some embodiments, the drill-down menu comprises options for narrowing a geographical location range for which the KPI value for each of the one or more selected KPIs is to be generated.

In some embodiments, the KPI value(s) for each of the one or more selected KPIs output to the display are arranged in columns and rows. The KPI value(s) for each of the one or more selected KPIs output to the display are arranged columns beneath a header corresponding to the selected one or more KPIs for which each KPI value is generated, and at least one of the one or more hierarchy inputs is arranged in a same row as the KPI value for each of the one or more selected KPIs corresponding to the at least one of the one or more hierarchy inputs.

In some embodiments, the network management platform 101 processes a selection of a header corresponding to one of the one or more selected KPIs, and causes a detail view of the selected KPI corresponding to the header is caused to be output to the display. In some embodiments, the detail view comprises the corresponding at least one of the one or more hierarchy inputs and one or more counters based upon which the KPI value of the selected KPI in the detail view is generated. The one or more counters are identifiers for KPI values corresponding to nodes of the communication network, and each of the one or more counters has a corresponding KPI value. In some embodiments, the at least one KPI value generated and output to the display is an average of the KPI values corresponding to the one or more counters. In some embodiments, the at least one KPI value generated and output to the display is a minimum value of the KPI values corresponding to the one or more counters. In some embodiments, the at least one KPI value generated and output to the display is a maximum value of the KPI values corresponding to the one or more counters.

In some embodiments, the network management platform 101 is configured to process a selection of at least one KPI value for the one or more selected KPIs and cause a graphical display of the at least one KPI value to be output to the display. In some embodiments, the graphical display comprises an option to view the at least one KPI value and historical KPI values corresponding to the at least one KPI value over time.

In some embodiments, the network management platform 101 is configured to process a selection of at least one data point in the graphical display representative of the at least one KPI value or at least one of the historical KPI values, and cause a list view of the at least one KPI value and the at least one historical KPI value corresponding to the selected at least one data point to be output to the display in a tabular format.

In some embodiments, the graphical user interface comprises a KPI monitoring refinement option configured to be launched from a monitoring interface comprising the KPI value for each of the one or more selected KPIs output to the display. In some embodiments, the KPI monitoring refinement option comprises an option input field configured to receive an input defining a duration unit of time for calculating the KPI value for each of the one or more selected KPIs. In some embodiments, the KPI monitoring refinement option comprises an option input field configured to receive an input defining at least one of a start date or a start time, and the KPI value is caused for each of the one or more selected KPIs output to the display to be based on KPI values generated for each of the one or more selected KPIs according to the duration unit of time from at least one of the start date or the start time until the KPI value for each of the one or more selected KPIs is output to the display. In some embodiments, the monitoring refinement option comprises an option input field configured to receive an input to modify the one or more hierarchy selection inputs to a higher hierarchy level or a lower hierarchy level, and the KPI value is changed for each of the one or more selected KPIs output to the display based on the modifying of the one or more hierarchy selection inputs. In some embodiments, the one or more hierarchy selection inputs modified by way of an option input field comprise as least one of a geographical location range or an equipment identifier of a type of equipment deployed in the communication network within the geographical location range.

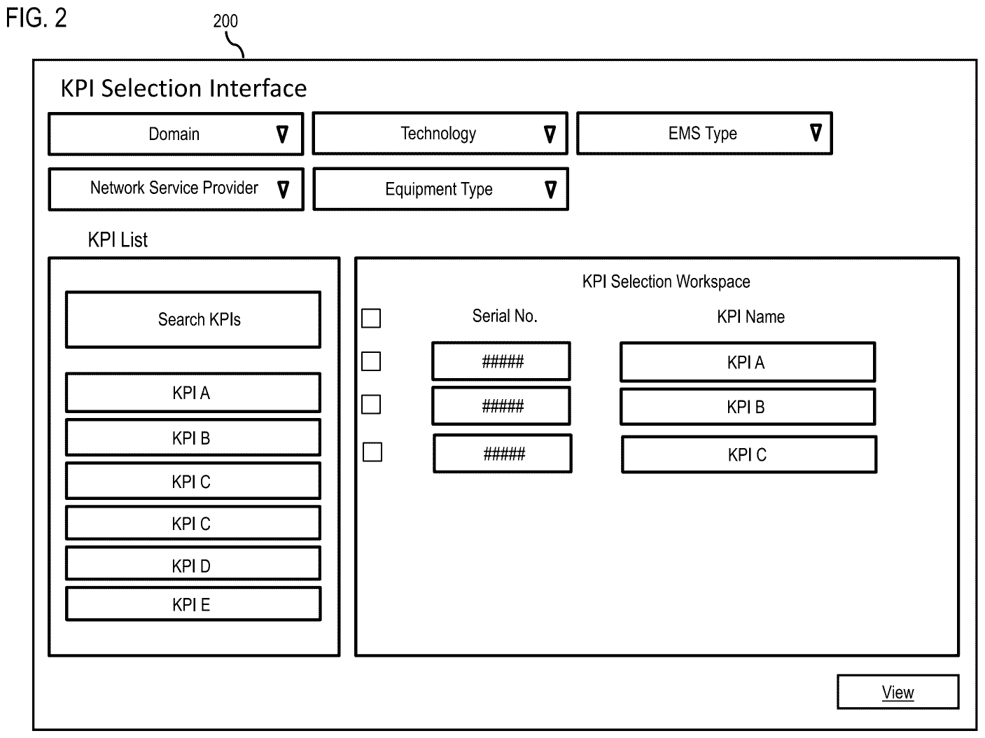

FIG. 2 is a diagram of a graphical user interface 200, in accordance with one or more embodiments. Network management platform 101 is configured to cause graphical user interface 200 to be output to a display.

Graphical user interface 200 is a KPI selection interface. Graphical user interface 200 includes a list of KPIs that are capable of being monitored by a user. Graphical user interface 200 facilitates selecting one or more of the KPIs included in the list of KPIs for monitoring. In some embodiments, the selection to view one or more KPIs included in the list of KPIs is made by dragging and dropping one or more KPIs from the list of KPIs to a KPI selection workspace included in graphical user interface 200. In some embodiments, the selection to view one or more KPIs included in the list of KPIs is made by doubling clicking, right clicking, or by some other suitable action, which causes one or more KPIs selected from the list of KPIs to populate the KPI selection workspace in the graphical user interface

Graphical user interface 200 includes a plurality of parameter input fields that are usable to narrow the quantity of KPIs included in the list of KPIs. Network management platform 101 is configured to filter the KPIs included in the list of KPIs by processing parameter selection inputs received by way of the parameter input fields included in graphical user interface 200.

Graphical user interface 200 includes parameter input fields configured to receive user inputs indicating a domain, a technology, a network service provider name, an EMS type and an equipment type. In some embodiments, graphical user interface 200 additionally or alternatively includes parameter input fields configured to receive user inputs indicating a node name or some other usable information identifiable in the system data upon which the KPIs are determined and based upon which the list of KPIs is capable of being narrowed. Graphical user interface 200 includes a search KPI input field configured to receive a user input for facilitating a search for KPIs included in the list of KPIs that match a user input word and/or number search. In some embodiments one or more of the parameter input fields is configured to receive a textual input from a user. In some embodiments, one or more of the parameter input fields or the search KPI input field facilitates selecting a parameter, or a word/number that is associated with a KPI included in the KPI list, by way of a drop-down box, radio button(s), check-box(es), or some other suitable manner.

Based on various user inputs received via the parameter selection input fields, network management platform 101 causes the list of KPIs in graphical user interface 200 to be narrowed. In some embodiments, the network management platform 101 is configured to narrow the list of KPIs based on a preset minimum quantity of parameter input fields that received at least one parameter selection input. In some embodiments, one or more of the parameter input fields are identified as being among the preset minimum quantity of parameter input fields. In some embodiments, a parameter input field is indicated as beings one of the minimum quantity of parameter input fields by way of a star, a bold font and/or border, color difference compared to other parameter input fields, a solid border vs a dashed border, black line vs greyed-out, or some other suitable indication.

In some embodiments, network management platform 101 may be configured to change the parameter input fields included in the minimum quantity of parameter input fields based on a combination of the parameter input field that receive a user input. For example, if the graphical user interface comprises five parameter input fields for domain, technology, EMS type, network service provider, and equipment type, and if the parameter input field for domain receives a parameter selection input, then the network management platform 101 may be configured to indicate that at least parameter input fields for network service provider and technology are to receive at least one parameter selection input before the network management platform 101 causes the list of KPIs to be narrowed, or some other suitable combination of parameter input fields. In some embodiments, the list of KPIs is caused to be narrowed based on a determination that all of the plurality of parameter input fields received at least one parameter selection input.

Graphical user interface 200 is shown in FIG. 2 as an example wherein KPI A, KPI B and KPI C are selected by causing the KPIs A-C to be added to KPI selection workspace. The KPI selection workspace includes at the KPI name and a serial number associated with the KPI. In some embodiments, the KPI selection workspace displays one of the serial number or the KPI name.

After a user has selected one or more KPIs, the user may then select a view option, a “next” option, or some other suitable instruction icon to cause the network management platform 101 to advance to a next step in monitoring the selected KPI(s).

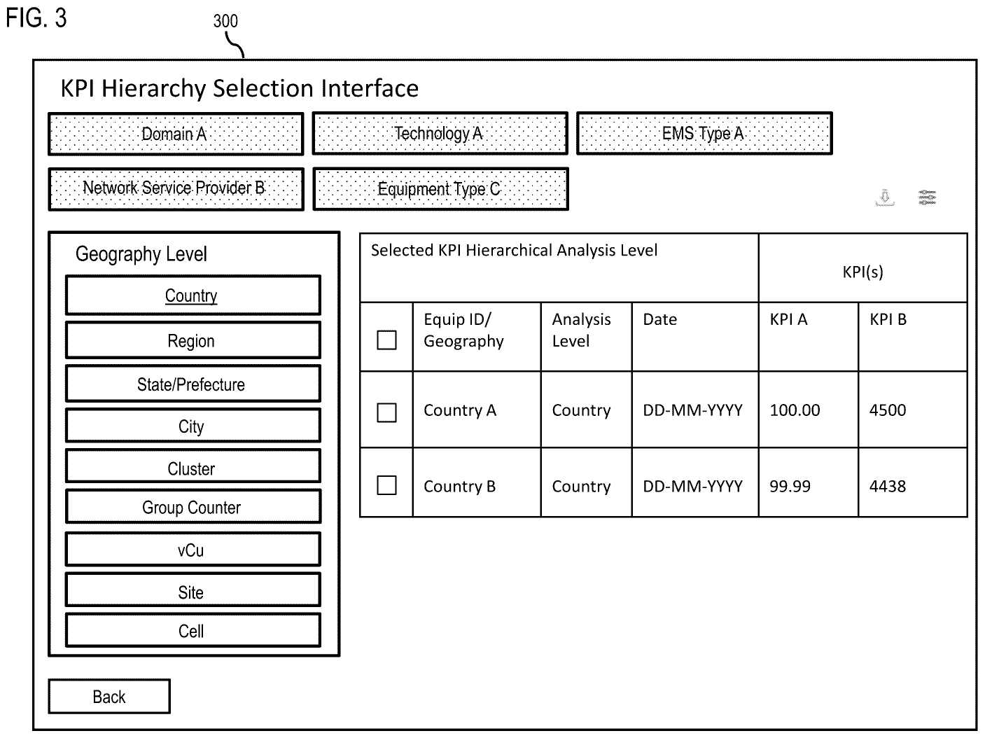

FIG. 3 is a diagram of a graphical user interface 300, in accordance with one or more embodiments. Network management platform 101 is configured to cause graphical user interface 300 to be output to a display.

Graphical user interface 300 is a KPI hierarchy selection interface. Graphical user interface 300 is caused to be displayed based on a user input to view the selected KPI(s) in graphical user interface 200 (FIG. 2).

Graphical user interface 300 includes hierarchy selection input options for narrowing a geographical location range for which a KPI value of the one or more selected KPIs is to be generated. At least one of the one or more hierarchy selection inputs is received by way of a drill-down menu in a geography level portion of graphical user interface 300.

In some embodiments, the narrowing geographical location range includes selecting one or more countries, one or more regions within each selected country, one or more states/prefectures within each selected region, one or more cities within each selection state/prefecture, one or more clusters within each selected city, one or more group counters within each selected cluster, one or more virtualized Central Unit (vCu) within each selected group counter, one or more sites within each selected cell, and/or one or more cells within each selected site.

In some embodiments, a lower-level option is made available based on a selection made in a higher level. In some embodiments, no lower level is made available until a higher level is first selected. In some embodiments, different combinations of hierarchical selection input options are included in graphical user interface 300.

The network management platform 101 processes one or more hierarchy selection inputs received by way of graphical user interface 300 and causes a KPI value for each of the one or more selected KPIs to be generated and displayed in graphical user interface 300 based on the one or more hierarchy selection inputs. In some embodiments, the KPI value(s) for each of the one or more selected KPIs are arranged in columns and rows such that the KPI value(s) for each of the one or more selected KPIs output to the display are arranged in columns beneath a header corresponding to the selected one or more KPIs for which each KPI value is generated. In some embodiments, at least one of the one or more hierarchy inputs is arranged in a same row as the KPI value for each of the one or more selected KPIs corresponding to the at least one of the one or more hierarchy inputs. For example, KPI values for selected KPI A and KPI B are included in a table in a same row as selected Country A at the country analysis level, and KPI values for selected KPI A and KPI B are included in the table in a same row as selected Country B at the country analysis level. This visual comparison makes it possible for a user to easily monitor the KPI values for the selected KPIs within a same hierarchy level (e.g., KPI A and KPI B within Country A) and/or different locations/clusters/counters, etc. (e.g., KPI A and KPI B within Country A and Country B).

In some embodiments, the network management platform 101 processes a selection of a header corresponding to one of the one or more selected KPIs, and causes a detail view of the selected KPI corresponding to the header to be output to the display. In some embodiments, selecting a header such as KPI A in graphical user interface 300 causes the detail view of KPI A to be displayed for all hierarchy levels for which values for KPI A have been generated. In some embodiments, graphical user interface facilitates selecting one or more of the rows having KPI values to be selected by, for example, checkboxes. Then, upon selecting one or more check boxes and selecting the header for KPI A, the detail view for KPI A for each of the selected rows is caused to be displayed.

Graphical user interface 300 includes the parameter inputs received by way of the parameter input fields included in graphical user interface 200 (FIG. 2). In this example, the parameter inputs are greyed-out and serve as a crumb trail to assist a user in understanding what parameters have been selected for narrowing the KPIs in graphical user interface 200. In some embodiments, a user may navigate back to graphical user interface 200 by selecting a “back” icon. In some embodiments, a user may navigate back to graphical user interface 200 by selecting one of the greyed-out parameter inputs in graphical user interface 300.

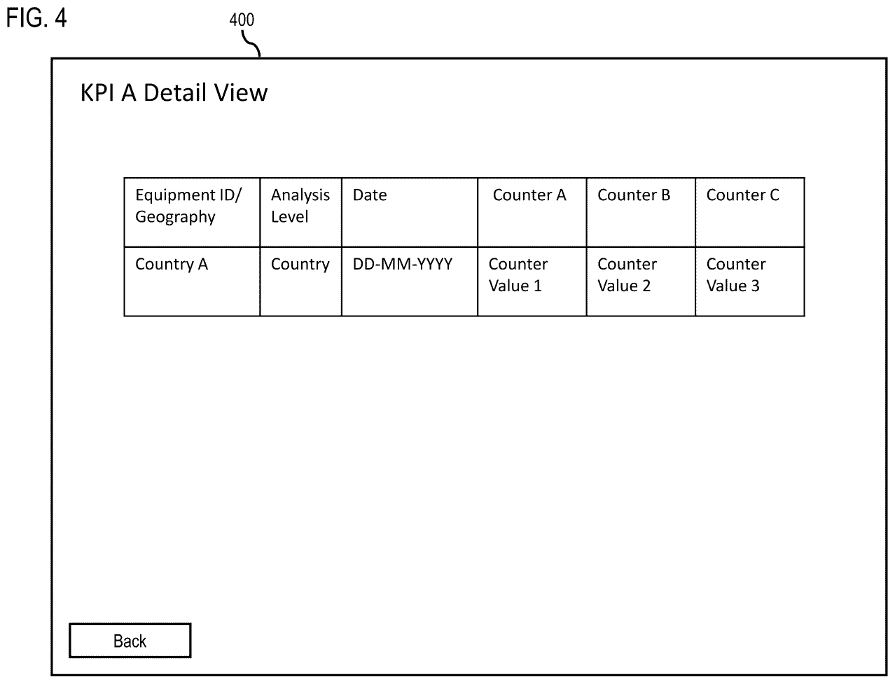

FIG. 4 is a diagram of a graphical user interface 400, in accordance with one or more embodiments. Network management platform 101 is configured to cause graphical user interface 400 to be output to a display.

Graphical user interface 400 is a detail view of KPI A that is caused to be displayed based on a selection of a corresponding header for KPI A and a row for Country A in graphical user interface 300 (FIG. 3).

In some embodiments, the detail view comprises at least one of the one or more hierarchy inputs and Counter A, Counter B and Counter C, based upon which the KPI value of the selected KPI in the detail view is generated. The one or more counters are identifiers for KPI values corresponding to nodes of the communication network, and each of the one or more counters has a corresponding KPI value.

In some embodiments, the network management platform 101 is configured to process a selection of at least one KPI value for the one or more selected KPIs and cause a graphical display of the at least one KPI value to be output to the display.

In some embodiments, a user may navigate back to graphical user interface 200 by selecting a “back” icon.

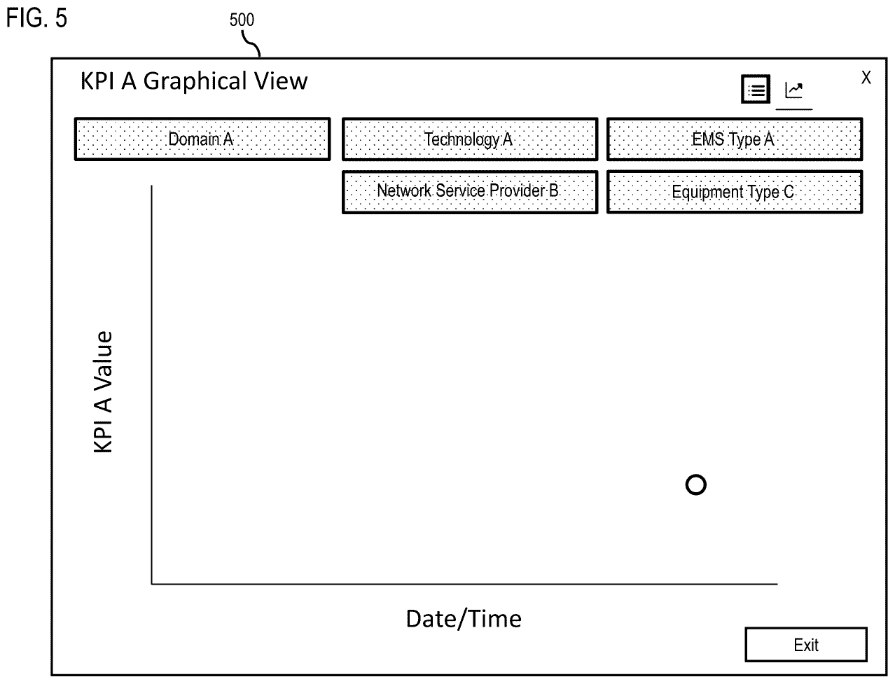

FIG. 5 is a diagram of a graphical user interface 500, in accordance with one or more embodiments. Network management platform 101 is configured to cause graphical user interface 500 to be output to a display.

Graphical user interface 500 is a graphical display of a selected KPI value in a graph that has KPI value in the y-axis and Date/Time for the KPI value in the x-axis. Graphical user interface 500 facilitates viewing at least one KPI value (e.g., the value for KPI A) and, optionally, historical KPI values corresponding to the at least one KPI value over time. In some embodiments, to populate the graphical view with historical KPI values, graphical user interface 500 includes a trend icon that, when selected, causes the network management platform 101 to retrieve historical KPI values from central data repository 103, for example.

In some embodiments, the network management platform 101 is configured to process a selection of at least one data point in the graphical display representative of the at least one KPI value or at least one of the historical KPI values, and cause a list view of the at least one KPI value and/or the at least one historical KPI value corresponding to the selected at least one data point to be output to the display in a tabular format. In some embodiments, graphical user interface 500 includes a list view option icon that is configured to toggle the tabular view upon being selected.

Graphical user interface 500 includes the parameter inputs received by way of the parameter input fields included in graphical user interface 200 (FIG. 2). In this example, the parameter inputs are greyed-out and serve as a crumb trail to assist a user in understanding what parameters have been selected for narrowing the KPIs in graphical user interface 200. In some embodiments, a user may navigate back to graphical user interface 200 by selecting one of the greyed-out parameter inputs in graphical user interface 500. In some embodiments, a user may navigate back to user interface 400 by selecting an exit icon or an “x” to close graphical user interface 500.

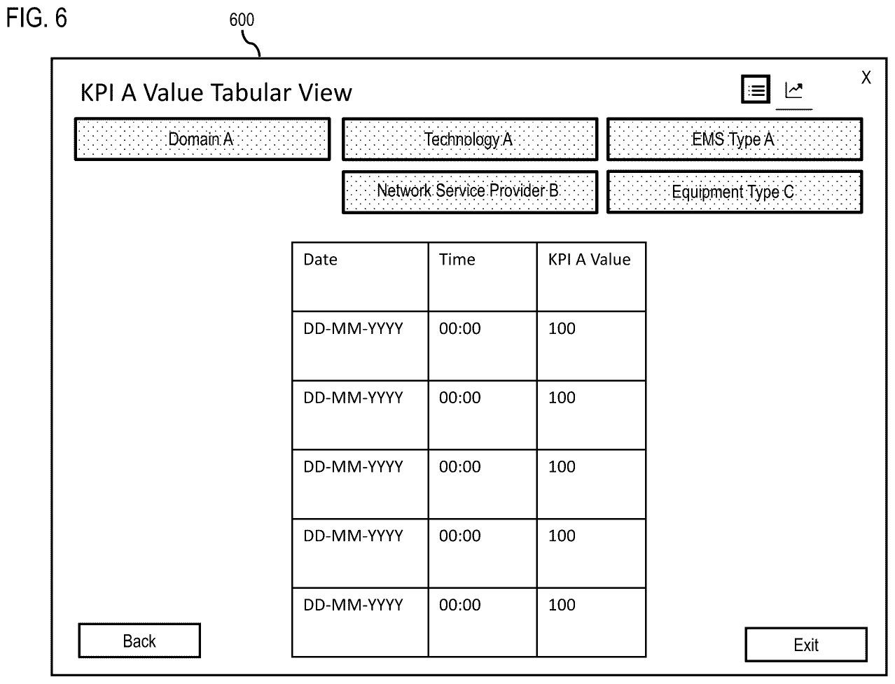

FIG. 6 is a diagram of a graphical user interface 600, in accordance with one or more embodiments. Network management platform 101 is configured to cause graphical user interface 600 to be output to a display.

Graphical user interface 600 is a list view of the at least one KPI value and at least one historical KPI value corresponding to the selected at least one data point for KPI A in a tabular format. Graphical user interface 600 is caused to be displayed based on a selection of a data point or the list view option icon in graphical user interface 500 (FIG. 5).

In some embodiments, to populate the list view with historical KPI values, graphical user interface 600 includes a trend icon that, when selected, causes the network management platform 101 to retrieve historical KPI values from central data repository 103, for example. In some embodiments, the list view includes the historical KPI values from graphical user interface 500 (FIG. 5) if the graphical view has been populated with historical KPI values before selecting the KPI data point or the list view option icon.

Graphical user interface 600 includes the parameter inputs received by way of the parameter input fields included in graphical user interface 200 (FIG. 2). In this example, the parameter inputs are greyed-out and serve as a crumb trail to assist a user in understanding what parameters have been selected for narrowing the KPIs in graphical user interface 200. In some embodiments, a user may navigate back to graphical user interface 200 by selecting one of the greyed-out parameter inputs in graphical user interface 600. In some embodiments, a user may navigate back to user interface 400 by selecting an exit icon or an “x” to close graphical user interface 600. In some embodiments, a user may navigate back to user interface 500 by selecting a “back” icon in graphical user interface 600.

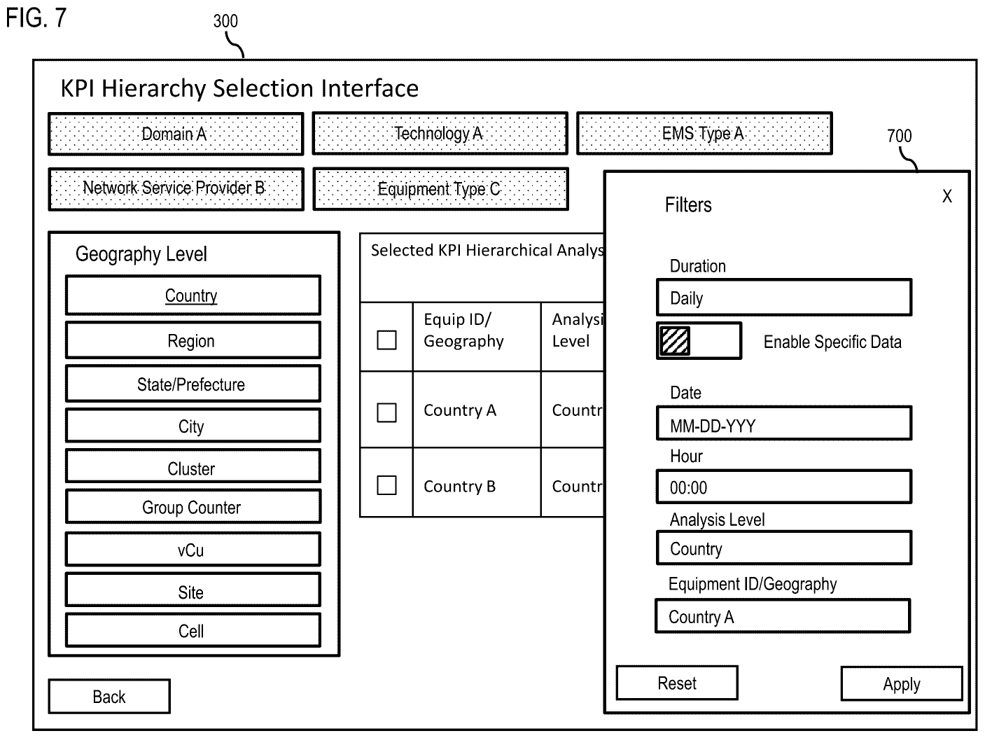

FIG. 7 is a diagram of a graphical user interface 700, in accordance with one or more embodiments. Network management platform 101 is configured to cause graphical user interface 700 to be output to a display.

Graphical user interface 700 is a KPI monitoring refinement option that is configured to be launched from graphical user interface 300 based on a selection of a filter icon in graphical user interface 300 (FIG. 3). Graphical user interface 700 shown in FIG. 7 as overlaying graphical user interface 300.

In some embodiments, graphical user interface 700 comprises an option input field configured to receive an input defining a duration unit of time for calculating the KPI value for each of the one or more selected KPIs. In some embodiments, graphical user interface 700 comprises an option input field configured to receive an input defining at least one of a start date or a start time. For example, the KPI value for each of the one or more selected KPIs output to the display in graphical user interface 300 is caused to be based on KPI values generated for each of the one or more selected KPIs according to the duration unit of time from at least one of the start date or the start time until the KPI value for each of the one or more selected KPIs is output to the display.

In some embodiments, graphical user interface 700 comprises an option input field configured to receive an input to modify the one or more hierarchy selection inputs to a higher hierarchy analysis level or a lower hierarchy analysis level, and the KPI value is changed for each of the one or more selected KPIs output to the display based on the modifying of the one or more hierarchy selection inputs.

In some embodiments, the one or more hierarchy selection inputs modified by way of an option input field in graphical user interface 700 comprise as least one of a geographical location range or an equipment identifier of a type of equipment deployed in the communication network within the geographical location range.

In some embodiments, prior to selecting the filter icon in graphical user interface 300, a user may select one or more of the rows for which the KPI value(s) are generated for purposes of applying the KPI monitoring refinement option(s) input by way of graphical user interface 700.

In some embodiments, to apply the KPI monitoring refinement option(s) input by way of graphical user interface 700, a user may select an “apply” icon. In some embodiments, to resent all of the KPI monitoring refinement options(s) input by way of graphical user interface 700, a user may select a “reset” icon in graphical user interface 700. To close user interface 700, a user may hit “x” in user interface 700.

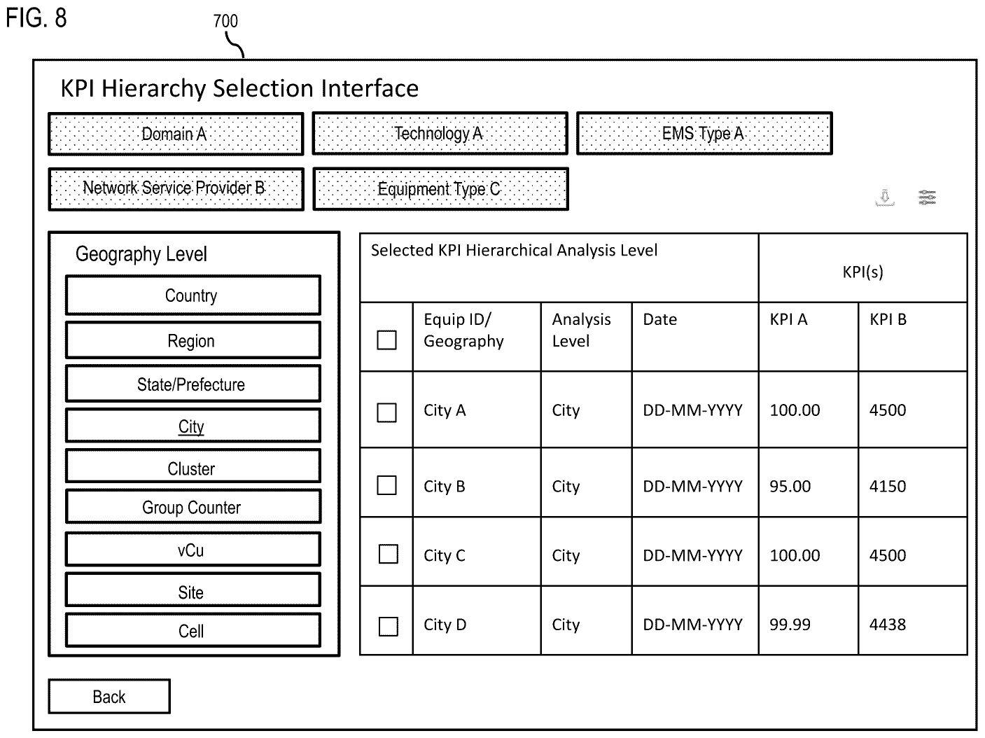

FIG. 8 is a diagram of a graphical user interface 300, in accordance with one or more embodiments.

Graphical user interface 300, as shown in FIG. 8, has an analysis level set at the City level for different cities, City A, City B, City C and City D. This level of granularity, for example, makes it possible for a user to view KPI values for selected KPIs, KPI A and KPI B in this example, in user interface 300.

Each of the options for changing the hierarchy analysis level, viewing the details associated with the KPI value(s), generating the graphical view of a selected KPI, selecting various refinement options, etc., are capable of being executed as discussed above.

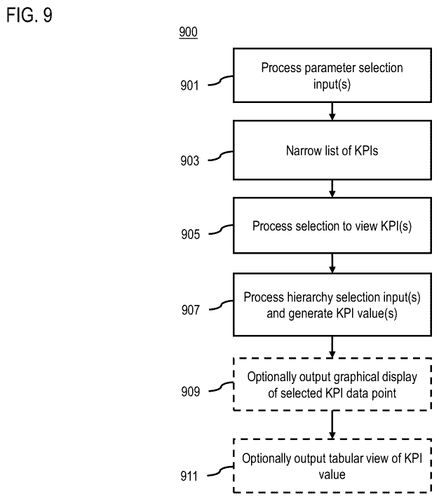

FIG. 9 is a flowchart of a process 900 for selective monitoring and displaying of one or more KPI values, in accordance with one or more embodiments. In some embodiments, the network management platform 101 (FIG. 1) performs the process 900.

In step 901, one or more parameter selection inputs received by way of a graphical user interface are processed. The graphical user interface comprises a plurality of parameter input fields. Each parameter input field of the plurality of parameter input fields is configured to receive a parameter selection corresponding to a detail for identifying one or more KPIs associated with monitoring a communication network.

In step 903, a list of KPIs in the graphical user interface is caused to be narrowed based on the processing of the one or more user inputs received by one or more of the plurality of parameter input fields. In some embodiments, the list of KPIs is caused to be narrowed based on a determination that all of the plurality of parameter input fields received at least one parameter selection input.

In step 905, a selection to view one or more KPIs included in the list of KPIs is processed.

In step 907, one or more hierarchy selection inputs received by way of the graphical user interface are processed to cause a KPI value for each of the one or more selected KPIs to be generated and output to a display based on the one or more hierarchy selection inputs. In some embodiments, at least one of the one or more hierarchy selection inputs is received by way of a drill-down menu in the graphical user interface. In some embodiments, the drill-down menu comprises options for narrowing a geographical location range for which the KPI value for each of the one or more selected KPIs is to be generated.

In some embodiments, the KPI value(s) for each of the one or more selected KPIs output to the display are arranged in columns and rows. The KPI value(s) for each of the one or more selected KPIs output to the display are arranged columns beneath a header corresponding to the selected one or more KPIs for which each KPI value is generated, and at least one of the one or more hierarchy inputs is arranged in a same row as the KPI value for each of the one or more selected KPIs corresponding to the at least one of the one or more hierarchy inputs.

In some embodiments, a selection of the header corresponding to one of the one or more selected KPIs is processed, and a detail view of the selected KPI corresponding to the header is caused to be output to the display. The detail view comprises the corresponding at least one of the one or more hierarchy inputs and one or more counters based upon which the KPI value of the selected KPI in the detail view is generated.

The one or more counters are identifiers for KPI values corresponding to nodes of the communication network, and each of the one or more counters has a corresponding KPI value. In some embodiments, the at least one KPI value generated and output to the display is an average of the KPI values corresponding to the one or more counters. In some embodiments, the at least one KPI value generated and output to the display is a minimum value of the KPI values corresponding to the one or more counters. In some embodiments, the at least one KPI value generated and output to the display is a maximum value of the KPI values corresponding to the one or more counters.

In some embodiments, the graphical user interface comprises a KPI monitoring refinement option configured to be launched from a monitoring interface comprising the KPI value for each of the one or more selected KPIs output to the display. In some embodiments, the KPI monitoring refinement option comprises an option input field configured to receive an input defining a duration unit of time for calculating the KPI value for each of the one or more selected KPIs. In some embodiments, the KPI monitoring refinement option comprises an option input field configured to receive an input defining at least one of a start date or a start time, and the KPI value is caused for each of the one or more selected KPIs output to the display to be based on KPI values generated for each of the one or more selected KPIs according to the duration unit of time from at least one of the start date or the start time until the KPI value for each of the one or more selected KPIs is output to the display. In some embodiments, the monitoring refinement option comprises an option input field configured to receive an input to modify the one or more hierarchy selection inputs to a higher hierarchy level or a lower hierarchy level, and the KPI value is changed for each of the one or more selected KPIs output to the display based on the modifying of the one or more hierarchy selection inputs. In some embodiments, the one or more hierarchy selection inputs modified by way of an option input field comprise as least one of a geographical location range or an equipment identifier of a type of equipment deployed in the communication network within the geographical location range.

In optional step 909, a selection of at least one KPI value for the one or more selected KPIs is processed to cause a graphical display of the at least one KPI value to be output to the display. The graphical display comprises an option to view the at least one KPI value and historical KPI values corresponding to the at least one KPI value over time.

In optional step 911, a selection of at least one data point in the graphical display representative of the at least one KPI value or at least one of the historical KPI values is processed, and a list view of the at least one KPI value and the at least one historical KPI value corresponding to the selected at least one data point is caused to be output to the display in a tabular format.

FIG. 10 is a functional block diagram of a computer or processor-based system 1000 upon which or by which an embodiment is implemented.

Processor-based system 1000 is programmed to selectively monitor and display one or more KPI values, as described herein, and includes, for example, bus 1001, processor 1003, and memory 1005 components.

In some embodiments, the processor-based system is implemented as a single “system on a chip.” Processor-based system 1000, or a portion thereof, constitutes a mechanism for performing one or more steps of selective monitoring and displaying of one or more KPI values.

In some embodiments, the processor-based system 1000 includes a communication mechanism such as bus 1001 for transferring and/or receiving information and/or instructions among the components of the processor-based system 1000. Processor 1003 is connected to the bus 1001 to obtain instructions for execution and process information stored in, for example, the memory 1005. In some embodiments, the processor 1003 is also accompanied with one or more specialized components to perform certain processing functions and tasks such as one or more digital signal processors (DSP), or one or more application-specific integrated circuits (ASIC). A DSP typically is configured to process real-world signals (e.g., sound) in real time independently of the processor 1003. Similarly, an ASIC is configurable to perform specialized functions not easily performed by a more general-purpose processor. Other specialized components to aid in performing the functions described herein optionally include one or more field programmable gate arrays (FPGA), one or more controllers, or one or more other special-purpose computer chips.

In one or more embodiments, the processor (or multiple processors) 1003 performs a set of operations on information as specified by a set of instructions stored in memory 1005 related to selectively monitor and display one or more KPI values. The execution of the instructions causes the processor to perform specified functions.

The processor 1003 and accompanying components are connected to the memory 1005 via the bus 1001. The memory 1005 includes one or more of dynamic memory (e.g., RAM, magnetic disk, writable optical disk, etc.) and static memory (e.g., ROM, CD-ROM, etc.) for storing executable instructions that when executed perform the steps described herein to selectively monitor and display one or more KPI values. The memory 1005 also stores the data associated with or generated by the execution of the steps.

In one or more embodiments, the memory 1005, such as a random-access memory (RAM) or any other dynamic storage device, stores information including processor instructions for selective monitoring and displaying of one or more KPI values. Dynamic memory allows information stored therein to be changed. RAM allows a unit of information stored at a location called a memory address to be stored and retrieved independently of information at neighboring addresses. The memory 1005 is also used by the processor 1003 to store temporary values during execution of processor instructions. In various embodiments, the memory 1005 is a read only memory (ROM) or any other static storage device coupled to the bus 1001 for storing static information, including instructions, that is not capable of being changed by processor 1003. Some memory is composed of volatile storage that loses the information stored thereon when power is lost. In some embodiments, the memory 1005 is a non-volatile (persistent) storage device, such as a magnetic disk, optical disk or flash card, for storing information, including instructions, that persists even when the system 1000 is turned off or otherwise loses power.

The term “computer-readable medium” as used herein refers to any medium that participates in providing information to processor 1003, including instructions for execution. Such a medium takes many forms, including, but not limited to computer-readable storage medium (e.g., non-volatile media, volatile media). Non-volatile media includes, for example, optical or magnetic disks. Volatile media include, for example, dynamic memory. Common forms of computer-readable media include, for example, a floppy disk, a flexible disk, a hard disk, a magnetic tape, another magnetic medium, a CD-ROM, CDRW, DVD, another optical medium, punch cards, paper tape, optical mark sheets, another physical medium with patterns of holes or other optically recognizable indicia, a RAM, a PROM, an EPROM, a FLASH-EPROM, an EEPROM, a flash memory, another memory chip or cartridge, or another medium from which a computer can read. The term computer-readable storage medium is used herein to refer to a computer-readable medium.

An aspect of this description is related to method comprising processing, by a processor, one or more parameter selection inputs received by way of a graphical user interface. The graphical user interface comprises a plurality of parameter input fields. Each parameter input field of the plurality of parameter input fields is configured to receive a parameter selection corresponding to a detail for identifying one or more key performance indicators (KPIs) associated with monitoring a communication network. The method also comprises causing a list of KPIs in the graphical user interface to be narrowed based on the processing of the one or more user inputs received by one or more of the plurality of parameter input fields. The method further comprises processing a selection to view one or more KPIs included in the list of KPIs. The method additionally comprises processing one or more hierarchy selection inputs received by way of the graphical user interface to cause a KPI value for each of the one or more selected KPIs to be generated and output to a display based on the one or more hierarchy selection inputs.

Another aspect of this description is related to an apparatus comprising a processor and a memory. The memory has instructions stored thereon that, when executed by the processor, cause the apparatus to process one or more parameter selection inputs received by way of a graphical user interface. The graphical user interface comprises a plurality of parameter input fields. Each parameter input field of the plurality of parameter input fields is configured to receive a parameter selection corresponding to a detail for identifying one or more key performance indicators (KPIs) associated with monitoring a communication network. The apparatus is also caused to cause a list of KPIs in the graphical user interface to be narrowed based on the processing of the one or more user inputs received by one or more of the plurality of parameter input fields. The apparatus is further caused to process a selection to view one or more KPIs included in the list of KPIs. The apparatus is additionally caused to process one or more hierarchy selection inputs received by way of the graphical user interface to cause a KPI value for each of the one or more selected KPIs to be generated and output to a display based on the one or more hierarchy selection inputs.

Another aspect of this description is related to a non-transitory computer readable having instructions stored thereon that, when executed by the processor, cause an apparatus to process one or more parameter selection inputs received by way of a graphical user interface. The graphical user interface comprises a plurality of parameter input fields. Each parameter input field of the plurality of parameter input fields is configured to receive a parameter selection corresponding to a detail for identifying one or more key performance indicators (KPIs) associated with monitoring a communication network. The apparatus is also caused to cause a list of KPIs in the graphical user interface to be narrowed based on the processing of the one or more user inputs received by one or more of the plurality of parameter input fields. The apparatus is further caused to process a selection to view one or more KPIs included in the list of KPIs. The apparatus is additionally caused to process one or more hierarchy selection inputs received by way of the graphical user interface to cause a KPI value for each of the one or more selected KPIs to be generated and output to a display based on the one or more hierarchy selection inputs.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method, comprising:
processing, by a processor, one or more parameter selection inputs received by way of a graphical user interface comprising a plurality of parameter input fields, each parameter input field of the plurality of parameter input fields being configured to receive a parameter selection corresponding to a detail for identifying one or more key performance indicators (KPIs) associated with monitoring a communication network;
causing a list of KPIs in the graphical user interface to be narrowed based on the processing of the one or more user inputs received by one or more of the plurality of parameter input fields;
processing a selection to view one or more KPIs included in the list of KPIs;
processing one or more hierarchy selection inputs received by way of the graphical user interface to cause a KPI value for each of the one or more selected KPIs to be generated and output to a display based on the one or more hierarchy selection inputs.

2. The method of claim 1, wherein the one or more hierarchy selection inputs is received by way of a drill-down menu in the graphical user interface.

3. The method of claim 2, wherein the drill-down menu comprises options for narrowing a geographical location range for which the KPI value for each of the one or more selected KPIs is to be generated.

4. The method of claim 1, wherein the list of KPIs is caused to be narrowed based on a determination that all of the plurality of parameter input fields received at least one parameter selection input.

5. The method of claim 1, further comprising:
processing a selection of at least one KPI value for the one or more selected KPIs to cause a graphical display of the at least one KPI value to be output to the display, wherein the graphical display comprises an option to view the at least one KPI value and historical KPI values corresponding to the at least one KPI value over time.

6. The method of claim 5, further comprising:
processing a selection of at least one data point in the graphical display representative of the at least one KPI value or at least one of the historical KPI values; and
causing a list view of the at least one KPI value and the at least one historical KPI value corresponding to the selected at least one data point to be output to the display in a tabular format.

7. The method of claim 1, wherein the KPI value for each of the one or more selected KPIs output to the display are arranged in columns and rows, the KPI value for each of the one or more selected KPIs output to the display are arranged columns beneath a header corresponding to the selected one or more KPIs for which each KPI value is generated, and at least one of the one or more hierarchy inputs is arranged in a same row as the KPI value for each of the one or more selected KPIs corresponding to the at least one of the one or more hierarchy inputs.

8. The method of claim 7, further comprising:
processing a selection of the header corresponding to one of the one or more selected KPIs; and
causing a detail view of the selected KPI corresponding to the header to be output to the display,
wherein the detail view comprises the corresponding at least one of the one or more hierarchy inputs and one or more counters based upon which the KPI value of the selected KPI in the detail view is generated.

9. The method of claim 8, wherein the one or more counters are identifiers for KPI values corresponding to nodes of the communication network, each of the one or more counters has a corresponding KPI value, and the at least one KPI value generated and output to the display is an average of the KPI values corresponding to the one or more counters.

10. The method of claim 8, wherein the one or more counters are identifiers for KPI values corresponding to nodes of the communication network, each of the one or more counters has a corresponding KPI value, and the at least one KPI value generated and output to the display is a minimum value of the KPI values corresponding to the one or more counters.

11. The method of claim 8, wherein the one or more counters are identifiers for KPI values corresponding to nodes of the communication network, each of the one or more counters has a corresponding KPI value, and the at least one KPI value generated and output to the display is a maximum value of the KPI values corresponding to the one or more counters.

12. The method of claim 1, wherein the graphical user interface comprises a KPI monitoring refinement option configured to be launched from a monitoring interface comprising the KPI value for each of the one or more selected KPIs output to the display, and the KPI monitoring refinement option comprises:
a first option input field configured to receive an input defining a duration unit of time for calculating the KPI value for each of the one or more selected KPIs.

13. The method of claim 12, wherein the monitoring refinement option further comprises a second option input field configured to receive an input defining at least one of a start date or a start time, and the method further comprises:
causing the KPI value for each of the one or more selected KPIs output to the display to be based on KPI values generated for each of the one or more selected KPIs according to the duration unit of time from at least one of the start date or the start time until the KPI value for each of the one or more selected KPIs is output to the display.

14. The method of claim 12, wherein the monitoring refinement option further comprises a second option input field configured to receive an input to modify the one or more hierarchy selection inputs to a higher hierarchy level or a lower hierarchy level, and the method further comprises:
changing the KPI value for each of the one or more selected KPIs output to the display based on the modifying of the one or more hierarchy selection inputs.

15. The method of claim 14, wherein the one or more hierarchy selection inputs modified by way of the second option input field comprise as least one of a geographical location range or an equipment identifier of a type of equipment deployed in the communication network within the geographical location range.

16. An apparatus, comprising:
a processor; and
a memory having instructions stored thereon that, when executed by the processor, cause the apparatus to:
process one or more parameter selection inputs received by way of a graphical user interface comprising a plurality of parameter input fields, each parameter input field of the plurality of parameter input fields being configured to receive a parameter selection corresponding to a detail for identifying one or more key performance indicators (KPIs) associated with monitoring a communication network;
cause a list of KPIs in the graphical user interface to be narrowed based on the processing of the one or more user inputs received by one or more of the plurality of parameter input fields;
process a selection to view one or more KPIs included in the list of KPIs; and
process one or more hierarchy selection inputs received by way of the graphical user interface to cause a KPI value for each of the one or more selected KPIs to be generated and output to a display based on the one or more hierarchy selection inputs.

17. The apparatus of claim 16, wherein the one or more hierarchy selection inputs is received by way of a drill-down menu in the graphical user interface.

18. The apparatus of claim 17, wherein the drill-down menu comprises options for narrowing a geographical location range for which the KPI value for each of the one or more selected KPIs is to be generated.

19. The apparatus of claim 16, wherein
the graphical user interface comprises a KPI monitoring refinement option configured to be launched from a monitoring interface comprising the KPI value for each of the one or more selected KPIs output to the display, and the KPI monitoring refinement option comprises:
a first option input field configured to receive an input defining a duration unit of time for calculating the KPI value for each of the one or more selected KPIs; and
a second option input field configured to receive an input defining at least one of a start date or a start time, and
the method further comprises:
causing the KPI value for each of the one or more selected KPIs output to the display to be based on KPI values generated for each of the one or more selected KPIs according to the duration unit of time from at least one of the start date or the start time until the KPI value for each of the one or more selected KPIs is output to the display.

20. A non-transitory computer readable medium having instructions stored thereon that, when executed by a processor, cause an apparatus to:
process one or more parameter selection inputs received by way of a graphical user interface comprising a plurality of parameter input fields, each parameter input field of plurality of parameters input fields being configured to receive a parameter selection indicative corresponding to a detail for identifying one or more key performance indicators (KPIs) associated with monitoring a communication network;
cause a list of KPIs in the graphical user interface to be narrowed based on the processing of the one or more user inputs received by one or more of the plurality of parameter input fields;
process a selection to view one or more KPIs included in the list of KPIs; and
process one or more hierarchy selection inputs received by way of the graphical user interface to cause a KPI value for each of the one or more selected KPIs to be generated and output to a display based on the one or more hierarchy selection inputs.
